(19) United States
(12) Patent Application Publication
(10) Pub. No.: US 2003/0168925 A1
(43) Pub. Date: Sep. 11, 2003

(54) Permanent magnet rotor

(76) Inventors: Georg Bernreuther, Nuernberg (DE); Anton Stadler, Hilpoltstein (DE)

Correspondence Address: JACOBSON HOLMAN PLLC, 400 SEVENTH STREET N.W., SUITE 600, WASHINGTON, DC, 20004, US

(21) Appl. No.: 10/280,077

(22) Filed: Oct. 25, 2002

(30) Foreign Application Priority Data
Oct. 25, 2001 (DE) 101 52 151.0

(51) Int. Cl. H02K 21/12

(52) U.S. Cl. 310/156.23

(57) ABSTRACT

A permanent magnet rotor, intended for an electric motor, comprises a permanent magnet ring, which is held by a plastic support element and a sliding bearing. The permanent magnet ring comprises a compressed plastic-bonded rare earth magnet. The sliding bearing is made of a sintered material. The plastic support element can be produced in an injection mold. The permanent magnet ring includes a cylindrical receptacle for the sliding bearing and is made as one piece with a pinion. The plastic support element envelops the permanent magnet ring at least partially in the axial and radial direction and the permanent magnet ring can be injected simultaneously as an insert in the injection mold.

### BACKGROUND OF THE INVENTION

1. Field of the Invention

The invention relates to a permanent magnet rotor for an electric motor. The rotor generally comprises a permanent magnet ring, which is held by a plastic support element and a sliding bearing.

2. Description of Related Art

German Patent Document DE-OS 199 09 227 A1 discloses a permanent magnet rotor, in which a yoke ring is cemented together with a permanent magnet. Such an adhesion holds reliably only in a limited temperature range. At higher temperatures, the cement can lose its adhesive force. Furthermore, the varying coefficients of temperature expansion result in stresses, which lead to cracks at the adhesion points of the plastic support element. In addition, the adhesive process is not economical because it is difficult to control the amount of cement that is applied.

European Patent Document EP 0 215 460 A2 discloses a permanent magnet rotor, where stresses, caused by varying coefficients of thermal expansion, are compensated for by recesses in the hub of the plastic support element.

German Patent Document DE 89 00 892 U1 discloses a permanent magnet rotor as a ceramic rotor cylinder without break-throughs and with face-sided plastic gatings enveloping shaft members. In this case the permanent magnet is provided with recesses, with which the plastic gatings engage.

German Patent Document DE 198 38 661 A1 describes a permanent magnet rotor with magnet segments, wherein the magnets are cemented on a laminated, soft magnetic rotor core, prior to encapsulation by injection molding.

An object of the invention is to produce for a permanent magnet rotor of the aforementioned class a reliable, simple and economical connection between the permanent magnet ring and the plastic support element without the magnet cracking; and that a long service life and good startup properties are guaranteed. In addition, a further object of the invention is also to guarantee that the mounting of the rotor is easy to produce and that it enables easy installation of the rotor into the housing of the electric motor and guarantees quieter operation.

This problem is solved in that the permanent magnet ring comprises a compressed plastic-bonded rare earth magnet; that a sliding bearing follows and is made of a sintered material; that a plastic support element can be produced in an injection mold; that the plastic support element comprises a cylindrical receptacle for the following sliding bearing and is made as one piece with a pinion; that the plastic support element envelops the permanent magnet ring at least partially in the axial and radial direction; and that the permanent magnet ring can be injected simultaneously as an insert in an injection mold. The use of the compressed plastic-bonded rare earth magnet enables a very thin and, therefore, low inertia rotor design. The sliding bearing made of sintered material extends the service life and decreases running noise. Owing to the axial and radial envelopment of the permanent magnet ring, the ring is held reliably and permanently. The fact that the plastic support element is made as one piece and the permanent magnet ring can be placed into an injection mold makes it possible to produce the permanent magnet rotor very economically. An even better mounting of the permanent magnet ring is achieved by means of a bilateral axial mounting in the plastic support element.

The pinion is preferably a component of a rotor shaft, designed as a hollow shaft. The permanent magnet rotor can be mounted easily on a stable axle, whereby the pinion is braced.

In addition to the magnet ring, a soft magnetic yoke ring can also be mounted on the inside circumference of the permanent magnet ring. It has the function of bundling the magnetic flux and of saving magnet material. The use of a soft magnetic sintered material as the yoke ring optimizes production.

To prevent relative twisting between the plastic support element and the yoke ring and/or the permanent magnet ring, the yoke ring and/or the permanent magnet ring are provided with recesses, which make a positive connection with the plastic support ring. In so doing, the recesses are arranged preferably on the face side. For a defined portion of the remainder of the sliding bearing, the recesses can be expanded in the inside area.

An especially advantageous further development of the permanent magnet rotor is provided with an additional bearing point, which is made as one piece with the plastic support element. This bearing point can be designed, for example, cylindrically or conically and braced against gear forces in the area of the pinion. The additional bearing results in two bearing points, which are far apart. The first bearing point is made of plastic and the other is formed by the mounted sliding bearing, thus resulting in a better guide of the permanent magnet rotor and significantly less noise. A lubricant depot, which supplies the sliding bearing with lubricant, serves to extend the service life.

The permanent magnet rotor is designed for better startup properties and for a method of injection molding that saves material. To this end, there are at least four and preferably nine spokes between the bearing and the permanent magnet ring and/or the yoke ring.

The plastic support ring is produced in an injection-molding machine. The permanent magnet ring and optionally the yoke ring are placed in the injection-molding machine, during which process the permanent magnet ring is pushed beforehand over the yoke ring.

Since the permanent magnet ring is very brittle, it is very important that it rests directly against the moldings of the injection mold during this injection molding process. Thus, the permanent magnet ring is well braced during the injection molding operation and can thus withstand the injection molding pressure.

It is very important that little or no plastic material can penetrate between the yoke ring and the permanent magnet ring, in order to prevent the magnet from cracking and creating asymmetries in the magnet. This goal can be reached through the use of spacers, which hold the permanent magnet ring and/or the soft magnetic yoke ring. The spacers are arranged coaxially to the permanent magnet ring, axially at the injection mold. Also, there are centering elements, which hold the permanent magnet ring and/or the soft magnetic yoke ring radially at its inside wall. Thus the spacers and the centering means enable an exact allocation between the permanent magnet ring and the yoke ring. The centering elements can be designed in the form of cylinder pins or ring segments. Preferably three centering elements are provided.

A preferred embodiment also comprises an actuator with a permanent magnet ring. It also includes a housing. A part of the housing includes a lubricant depot for lubricating the bearing of the permanent magnet rotor, in which the permanent magnet rotor is mounted. The lubricant depot is designed in the form of a ring-shaped groove, into which a ring-shaped molded-on member of the permanent magnet rotor projects and can thus accept the lubricant and pass it to the bearing. This molded-on member is made as one piece with the plastic support element for easier production.

An especially sturdy mounting for easy motion is achieved in that the permanent magnet rotor is received on a stationary axle that is installed in the housing. This axle is designed especially as a metal axle about which the two bearings of the permanent magnet rotor revolve. The axle can be made of hardened steel. If the core is soft, surface hardening is also expedient—it reduces noise propagation. For the same reason the surface of the axle can also be nickel-plated.

The permanent magnet rotor includes a shaft between the magnetic area and the pinion. The permanent magnet ring can be arranged in a motor chamber; and the pinion, in a gear chamber, so that both chambers are separated from each other by means of an intermediate plate with an axial passage. In the motor chamber two parts of the stator are fastened on the intermediate plate and arranged radially around the rotor. The pinion engages with a reducing gear in a gear chamber. In this arrangement the lubricant is stored in the motor chamber.

### BRIEF DESCRIPTION OF THE SEVERAL VIEWS OF THE DRAWINGS

The invention is explained in detail below with reference to one embodiment and variants thereof.

FIG. 1a is a cross sectional view of a permanent magnet rotor.

FIG. 1b is a cross sectional view of a permanent magnet rotor with a yoke ring.

FIG. 1c is a cross sectional view of a permanent magnet rotor with a second cylindrical bearing.

FIG. 1d is a cross sectional view of a permanent magnet rotor with a second conically arranged bearing.

FIG. 2 is a three dimensional drawing of a permanent magnet ring (scale deviates from the other figures); and

FIG. 3 is an exploded drawing of an actuator with a The permanent magnet rotor embodying the present invention.

FIG. 4 is a block diagram of a method for making a permanent magnet rotor.

FIG. 5 is a block diagram of an other method for making a permanent magnet rotor.

### DETAILED DESCRIPTION OF THE INVENTION

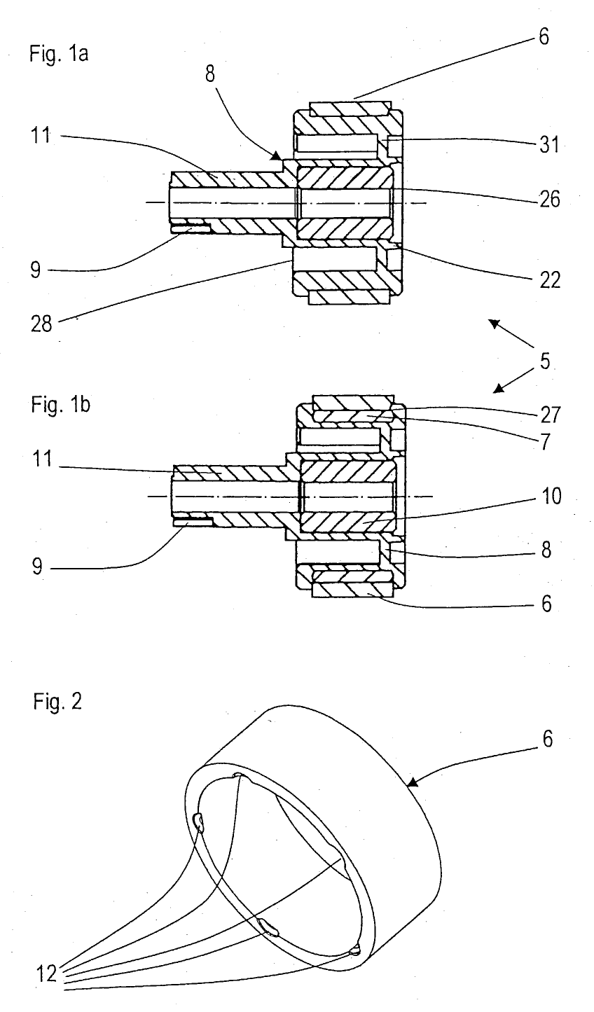

FIG. 1a shows a permanent magnet rotor 5 with a plastic support element 8 and a permanent magnet ring 6. The plastic support element 8 has a centrally located receptacle 26 for a bearing to be mounted, a rotor shaft 11, which is designed as a hollow shaft and on whose end a pinion 9 is molded. The pinion 9 is offset axially in relation to the permanent magnet ring 6 so that it is possible to separate the gear area from the motor area. The permanent magnet ring 6 is enveloped on the face side in part by the plastic support element 8. On the one hand, the permanent magnet ring 6 is free in the radial direction, thus keeping the air gap very narrow. On the other hand, the permanent magnet ring 6 rests against the plastic support element 8. The receptacle 26 is dimensioned in such a manner to receive a sliding bearing 10, in particular a sintered sliding bearing. The sliding bearing 10 follows with the rotor 5, the sliding bearing running on a stationary axle and being saturated with lubricant.

FIG. 1b shows a permanent magnet rotor 5, which, besides the structural elements in FIG. 1a, includes a yoke ring 7 positioned between the faces of the permanent magnet ring and the plastic support element. A ring-shaped molded-on member 22 is made as one piece with the plastic support element 8. The molded-on member serves to receive lubricant, which is introduced into a ring-shaped lubricant depot in a part of the motor housing. Thus, a long service life is possible so that the rotor can also be installed in long-lived brushless motors. To avoid the accumulation of material, the area between the yoke ring 7 and the storage receptacle 26 is significantly hollowed out; only a disk-shaped hub 31 and several spokes 28 remain. In the present example there are four spokes.

FIG. 1c shows a permanent magnet rotor like that of FIG. 1a, further including a second cylindrical bearing point 29a.

FIG. 1d shows a permanent magnet rotor like that of FIG. 1a, further including a second conical bearing point 29b. For easier removal from the mold, it is expedient to provide a small undercut. The undercut can be formed, for example, by means of the second bearing point. Other embodiments of an undercut 30 are also contemplated.

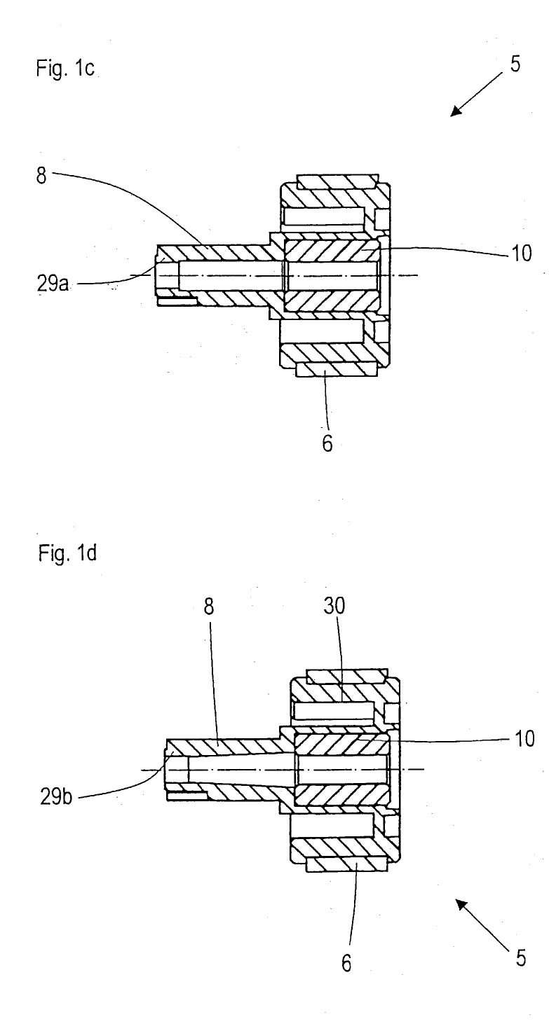

FIG. 2 shows a three-dimensional drawing of a permanent magnet ring 6, which is provided with recesses 12 in the area adjoining the plastic support element 8. These recesses can be molded with the plastic material of the plastic support element to prevent rotation. Even the yoke ring can be provided with anti-rotational recesses. In this manner the magnetically acting parts and the plastic support element are permanently connected together. Following magnetization, the permanent magnet ring has five pairs of magnetic poles, where each pole assumes 36 degrees of the circumference. The magnetization is radially oriented so that the magnetic field lines run antiparallel at the pole transitions.

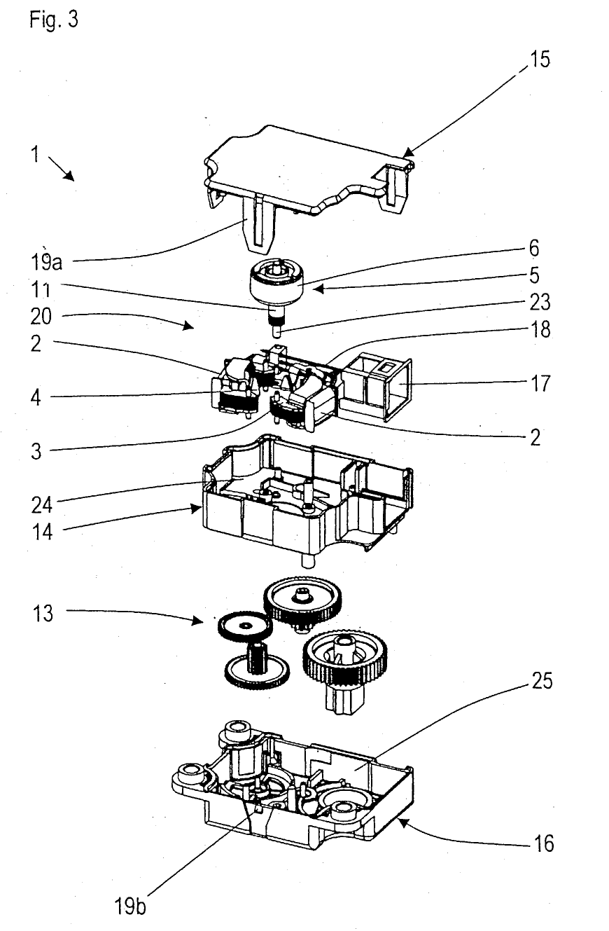

FIG. 3 shows an exploded drawing of an actuator 1, with an electric motor 20, comprising two wound stator parts 2, with main poles 3 and additional poles 4, which are attached to an intermediate plate 14, the permanent magnet rotor 5, contact pins 18, and a plug shaft 17. The intermediate plate 14 and a part of the motor housing 15 define a motor chamber 24. A reducing gear 13 is disposed in a gear chamber 25. Finally, a steel axle 23 for receiving the permanent magnet rotor 5 with the rotor shaft 11 is mounted in the motor chamber 24. The gear chamber 25 is defined by the intermediate plate 14 and a part of the gear housing 16. The axial offset between the pinion 9 and the permanent magnet ring 6 and the intermediate plate 14, serving as the motor carrier, enable preassembly of all motor parts, optionally also of the electronic components, like actuation and interference suppression in a module, which is separate from the reducing gear. This module is assembled from other preassembled modules, starting with the stator parts 2, which are provided with an insulating body and then wound. Then the windings are soldered to the contact pins 18. To this end, the contact pins vary in length. The longer contact pins mechanically connect the two insulating bodies together.

The ends of the contract pins form the contacts in a plug shaft 17 in order to connect to an attachment plug (not shown). Prior to installation in the intermediate plate 14, the stator parts 2 are provided with additional poles 4, which are made of bent, soft magnetic individual parts of sheet steel. In contrast, the main poles 3 are made of packaged soft magnetic sheets. The sheet steel parts of the main and additional poles 3 and 4 are connected by means of pins, which are forced in and whose elongated ends are put into the depressions in the intermediate plate 14 and the motor housing part 15. The additional poles exhibit hexagonal recesses, which are pressed on projecting pins that are made as one piece with the intermediate plate.

Each main pole 3 and each additional pole 4 of one part of the stator 2 is opposite a rotor pole, whereas each main pole 3 and additional pole 4 of the second part of the stator 2 is opposite a pole transition area. The additional poles are chamfered in alternating directions in order to reduce the click-stop moment. At one point on the periphery of the rotor the slopes also prevent the additional poles from touching and/or overlapping and thus magnetic short-circuiting. The angular distance between the main poles 3 of each part of the stator parts 2 is 108 degrees.

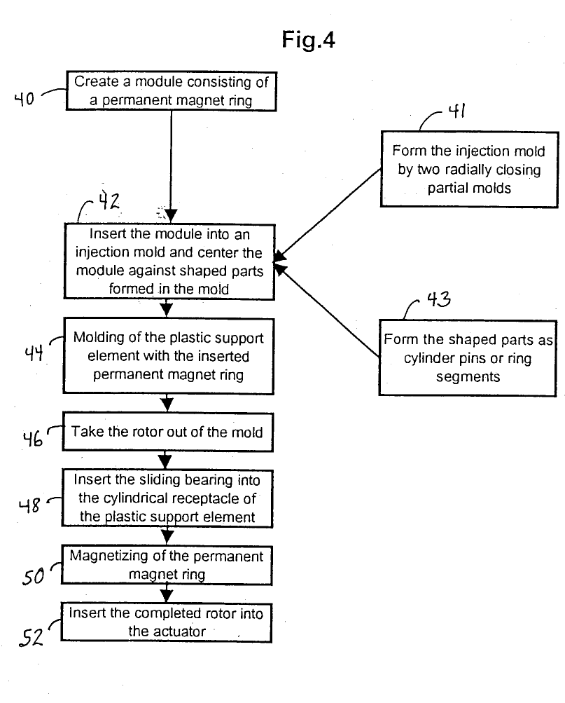

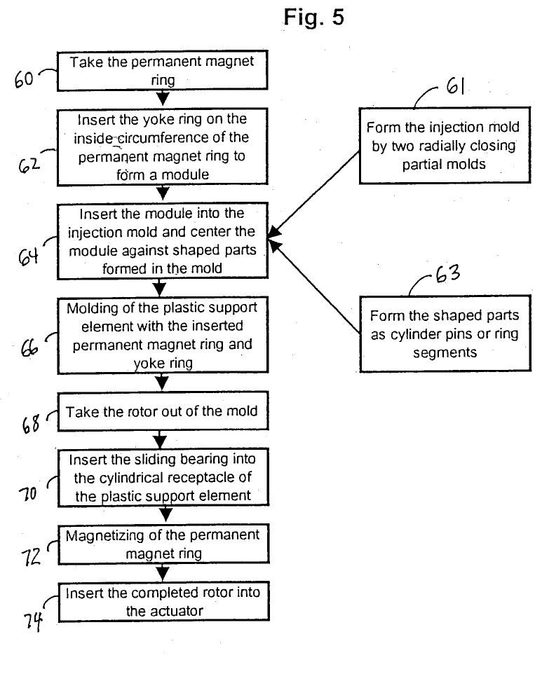

To manufacture the permanent magnet rotor 5, two processes are shown in FIGS. 4 and 5. The difference between the two processes is that the process of FIG. 4 uses only a permanent magnet ring 6 to form a module, whereas the process of FIG. 5 uses a permanent magnet ring and a yoke ring 7 to form a module.

In the FIG. 4 embodiment, the module (Step 40) comprising the permanent magnet ring 6 is placed into a cylindrical receptacle of an injection mold (step 42), which is formed by two radially closing partial molds (Step 41). These radially closing partial molds provide that the module is precentered through the use of shaped parts formed in the mold (Step 42). The shaped parts are formed as cylinder pins or ring segments (Step 43). When the mold is closed, the partial molds move radially together and envelop the permanent magnet ring 6. When the plastic is injected through the injection channels (Step 44), high pressure is exerted on the permanent magnet ring 6 and then transferred to the mold. The partial molds brace the magnet. Owing to the exact centering and the resulting exact reception in the partial molds, magnet ruptures are virtually ruled out.

The rotor is then taken out of the mold (Step 46) after which the sliding bearing 10 is inserted into a cylindrical receptacle formed in the plastic support member 8 (Step 48). Magnetization takes place preferably immediately before the permanent magnet rotors are installed into the drive (Steps 50 and 52), thus avoiding the need to be especially considerate of the permanent magnet rotors sticking together magnetically and that the metal cuttings adhere thereto, a feature that can result in malfunctions in operation or failure of the electric motor.

In the FIG. 5 embodiment, the module (Step 60) comprising the permanent magnet ring 6 and yoke ring 7 are put in or on each other (Step 62) and then placed into a cylindrical receptacle of an injection mold (step 64), which is formed by two radially closing partial molds (Step 61). These radially closing partial molds provide that the module is precentered through the use of shaped parts formed in the mold (Step 42). The shaped parts are formed as cylinder pins or ring segments (Step 63). When the mold is closed, the partial molds move radially together and envelop the permanent magnet ring 6. When the plastic is injected through the injection channels (Step 66), high pressure is exerted on the permanent magnet ring 6 and then transferred to the mold. The partial molds brace the magnet. Owing to the exact centering and the resulting exact reception in the partial molds, magnet ruptures are virtually ruled out. The injection pressure on the permanent magnet ring 6 can be partially intercepted by the yoke ring 7. The yoke ring is usually made of an expandable soft magnetic sintered material.

The rotor is then taken out of the mold (Step 68) after which the sliding bearing 10 is inserted into a cylindrical receptacle formed in the plastic support member 8 (Step 70). Magnetization takes place preferably immediately before the permanent magnet rotors are installed into the drive (Steps 72 and 74), thus avoiding the need to be especially considerate of the permanent magnet rotors sticking together magnetically and that the metal cuttings adhere thereto, a feature that can result in malfunctions in operation or failure of the electric motor.

The centering elements, formed on the yoke ring by means of the mold, ensure that the yoke ring 7 is not deformed by means of the high pressure of the injection molding process. This prevents the formation of a gap between the permanent magnet ring 6 and the yoke ring 7. After the injection molding process or the magnetization, such a gap can cause the permanent magnet ring 6 “to explode”.

The present invention may be embodied in other specific forms without departing from its spirit or essential characteristics. The described embodiments are to be considered as illustrative and not restrictive. The scope of the invention is therefore indicated by the appended claims rather than by the foregoing description. All changes, which come within the meaning and range of equivalency of the claims, are to be embraced within their scope.

What is claimed is:

1. A The permanent magnet rotor, which is intended for an electric motor, the rotor comprising:
a plastic support element made by injection molding using a mold;
a sliding bearing made of a sintered material;
a permanent magnet ring, which is held by the plastic support element and the sliding bearing, the permanent magnet ring including
a compressed plastic-bonded rare earth magnet,
a cylindrical receptacle having an inner area for receiving the sliding bearing, the receptacle being made as one piece with a pinion, wherein the plastic support element envelops the permanent magnet ring at least partially in the axial and radial direction.

2. The permanent magnet rotor, as claimed in claim 1, wherein the permanent magnet ring includes means for axially holding the plastic support element on both sides.

3. The permanent magnet rotor, as claimed in claim 1, further comprises a hollow rotor shaft attached to the support element, the rotor shaft including the pinion.

4. The permanent magnet rotor, as claimed in claim 1, wherein a yoke ring is attached on the inside circumference of the permanent magnet ring.

5. The permanent magnet rotor, as claimed in claim 4, wherein the yoke ring is made of a soft magnetic sintered material.

6. The permanent magnet rotor, as claimed in claim 4, wherein the yoke ring is axially shorter than the permanent magnet ring.

7. The permanent magnet rotor, as claimed in claim 4, wherein the yoke ring exhibits at least one peripheral chamfer, which faces the permanent magnet ring.

8. The permanent magnet rotor, as claimed in claim 4, wherein the yoke ring contains recesses, which prevent twisting relative to the plastic support element.

9. The permanent magnet rotor, as claimed in claim 1, wherein the permanent magnet ring contains recesses, which prevent twisting relative to the plastic support element.

10. The permanent magnet rotor, as claimed in claim 8, wherein the recesses are arranged on the face side of the yoke ring.

11. The permanent magnet rotor, as claimed in claim 8, wherein the recesses are rounded or trapezoidal.

12. The permanent magnet rotor, as claimed in claim 1, wherein the sliding bearing is expanded in the inner area.

13. The permanent magnet rotor, as claimed in claim 1, wherein the sliding bearing includes a shoulder at an inside diameter.

14. The permanent magnet rotor, as claimed in claim 1, further comprising a second bearing point, which is formed in one piece with the plastic support element.

15. The permanent magnet rotor, as claimed in claim 14, wherein the second bearing point is shaped cylindrically.

16. The permanent magnet rotor, as claimed in claim 14, wherein the second bearing point is shaped conically.

17. The permanent magnet rotor, as claimed in claim 1, further comprising a lubricant depot for supplying the sliding bearing with lubricant.

18. The permanent magnet, as claimed in claim 1, further comprising at least four ejectors distributed over the circumference in the area of the face side of the permanent magnet ring.

19. The permanent magnet, as claimed in claim 1, wherein the plastic support element includes at least four spokes which are arranged radially and distributed uniformly over the circumference.

20. The permanent magnet, as claimed in claim 1, wherein the plastic support element includes an undercut for removing from the mold the cylindrical receptacle for the sliding bearing.

21. A process for the production of the permanent magnet rotor of claim 1, wherein, prior to the injection molding in the mold, the permanent magnet ring is slid over the yoke ring.

22. The process, as claimed in claim 21, wherein the permanent magnet ring and the yoke ring are inserted together into the mold.

23. The process, as claimed in claim 21, wherein the permanent magnet ring rests directly against shaped parts formed in the injection mold during injection molding.

24. The process, as claimed in claim 21, wherein the permanent magnet ring and/or the magnetic yoke ring, which is arranged coaxially to the permanent magnet ring, is/are held axially at the mold by means of spacers; and between the spacers in an area, bordering the permanent magnet ring and/or the soft magnetic yoke ring, arranged coaxially to the permanent magnet ring, the plastic material of the plastic support element is injected into the mold.

25. A process for the production of a permanent magnet rotor for an electric motor or a rotary magnet with a plastic support element comprising the steps of:
holding a permanent magnet ring and/or a magnetic yoke ring, which is arranged coaxially to the permanent magnet ring, at least radially by centering elements of an injection mold on the inner wall of the mold; and
injecting the plastic material of the plastic support element in such a manner that there is a positive connection between the plastic support element and the permanent magnet ring and/or the soft magnetic yoke ring.

26. The process, as claimed in claim 25, wherein cylinder pins or ring segments are provided as the centering elements.

27. The process, as claimed in claim 25, wherein a sliding bearing is injected simultaneously in the mold.

28. An actuator with the permanent magnet rotor of claim 17 and a housing that receives the rotor, wherein the lubricant depot is arranged in the part of the housing in which the permanent magnet rotor is disposed.

29. The actuator, as claimed in claim 28, wherein the lubricant depot is designed as a ring-shaped groove, which is filled with lubricant and is arranged coaxially to the axis of rotation of the permanent magnet rotor.

30. The actuator, as claimed in claim 28, wherein the permanent magnet rotor includes a molded-on member, projecting into the lubricant depot.

31. The actuator, as claimed in claim 30, wherein the molded-on member is made as one piece with the plastic support element and includes an annular cross section.

32. The actuator, as claimed in claim 28, wherein the permanent magnet rotor is pivotally mounted on an axle, and is held between a first and a second part of the housing.

33. The actuator, as claimed in claim 32, wherein the axle is designed as a stationary metal axle, about which the bearings rotate.

34. The actuator, as claimed in claim 32, wherein the axle is made of hardened steel.

35. The actuator, as claimed in claim 34, wherein the axle is surface hardened with a soft steel core.

36. The actuator, as claimed in claim 32, wherein the axle is nickel-plated on the surface.

37. The actuator, as claimed in claim 28, further comprising an electric motor with stator parts fastened on an intermediate plate, which separates a motor chamber from a gear chamber, wherein the permanent magnet ring is arranged in the motor chamber; and the pinion projects beyond the rotor shaft in the gear chamber and engages there with a reducing gear.

38. The actuator, as claimed in claim 37, wherein the lubricant depot is disposed in the motor chamber.
